(19) United States
(12) Patent Application Publication
(10) Pub. No.: US 2024/0340632 A1
(43) Pub. Date: Oct. 10, 2024

(54) SYSTEMS AND METHODS FOR IDENTIFYING SUBSCRIPTION-BASED UNMANNED AERIAL VEHICLE (UAV)

(71) Applicant: ZTE Corporation, Shenzhen (CN)

(72) Inventors: Yansheng LIU, Shenzhen (CN); Yin GAO, Shenzhen (CN); Dapeng LI, Shenzhen (CN); Jiren HAN, Shenzhen (CN)

(73) Assignee: ZTE Corporation, Shenzhen, Guangdong (CN)

(21) Appl. No.: 18/750,035

(22) Filed: Jun. 21, 2024

Related U.S. Application Data
(63) Continuation of application No. PCT/CN2022/106829, filed on Jul. 20, 2022.

(51) Int. Cl. H04W 8/18; H04W 76/20; H04W 84/06

(52) U.S. Cl. CPC H04W 8/183; H04W 76/20; H04W 84/06

(57) ABSTRACT

Presented are systems and methods for identifying subscription-based unmanned aerial vehicle (UAV). A wireless communication node may receive a first message including one or more configuration containers from a network. The one or more configuration containers include various information associated with a terminal service. The one or more configuration containers may correspond to different radio access technologies (RATs).

### CROSS-REFERENCE TO RELATED APPLICATION

This application claims the benefit of priority under 35 U.S.C. § 120 as a continuation of International Patent Application No. PCT/CN2022/106829, filed on Jul. 20, 2022, the disclosure of which is incorporated herein by reference in its entirety.

### TECHNICAL FIELD

The disclosure relates generally to wireless communications, including but not limited to systems and methods for identifying subscription-based unmanned aerial vehicle (UAV).

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based, and some being hardware based, so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, method, apparatus, or a computer-readable medium of the following. A wireless communication node (e.g., a BS) may receive a first message including one or more configuration containers from a network (e.g., a CN). The one or more configuration containers may include various information associated with a terminal (e.g., an unmanned aerial vehicle (UAV)) service. The one or more configuration containers may correspond to different radio access technologies (RATs).

In some embodiments, the one or more configuration containers may include at least one of a Long-Term Evolution (LTE) configuration container or a New Radio (NR) configuration container. The various information may include at least one of: UAV identification configured to identify a wireless communication device; UAV subscription information configured to notify the wireless communication node that the wireless communication device is qualified to use the UAV service; one or more report receiver's addresses to which UAV data is to be collected; UAV location information configuring UAV location measurement and reporting; height reporting information associated with the wireless communication device; flight path information associated with the wireless communication device; or measurement information including frequency-related information of the wireless communication device.

In some embodiments, the wireless communication node may receive a second message including a UAV specific preamble from a wireless communication device (e.g., a UE). The wireless communication node may send a third message including at least one of: identification of the wireless communication device or an UAV identification query indicator to the network. The UAV identification query indicator can be configured to query the network whether the identification of the wireless communication device has subscribed to the UAV service. The wireless communication node may receive a fourth message confirming that the wireless communication device has subscribed to the UAV service from the network. The fourth message may include at least one of: the identification of the wireless communication device; UAV identification; UAV subscription information; or the one or more configuration containers

In some embodiments, the wireless communication node may receive a second message which can be a Radio Resource Control (RRC) message from a wireless communication device. The second message may include at least one of: identification of the wireless communication device or UAV identification. The wireless communication node may send a third message including at least one of: the identification of the wireless communication device; the UAV identification; or an UAV identification query indicator to the network. The wireless communication node may receive a fourth message confirming that the wireless communication device has subscribed to the UAV service from the network. The fourth message may includes at least one of: the identification of the wireless communication device; the UAV identification; UAV subscription information; or the one or more configuration containers.

In some embodiments, in response to the network receiving a Non-Access Stratum (NAS) message from a wireless communication device that includes at least one of identification of the wireless communication device or UAV identification, the wireless communication node may receive a first message confirming that the wireless communication device has subscribed to the UAV service from the network. The first message may include at least one of: the identification of the wireless communication device; the UAV identification; UAV subscription information; or the one or more configuration containers.

In some embodiments, a network (e.g., a CN) may send a first message including one or more configuration containers to a wireless communication node (e.g., a BS). The one or more configuration containers may include various information associated with a terminal (e.g., an unmanned aerial vehicle (UAV)) service. The one or more configuration containers may correspond to different radio access technologies (RATs).

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and case of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates a sequence diagram illustrating preamble based unmanned aerial vehicle (UAV) identification configuration, in accordance with some embodiments of the present disclosure;

FIG. 4 illustrates a sequence diagram illustrating user equipment (UE) based unmanned aerial vehicle (UAV) identification configuration, in accordance with some embodiments of the present disclosure;

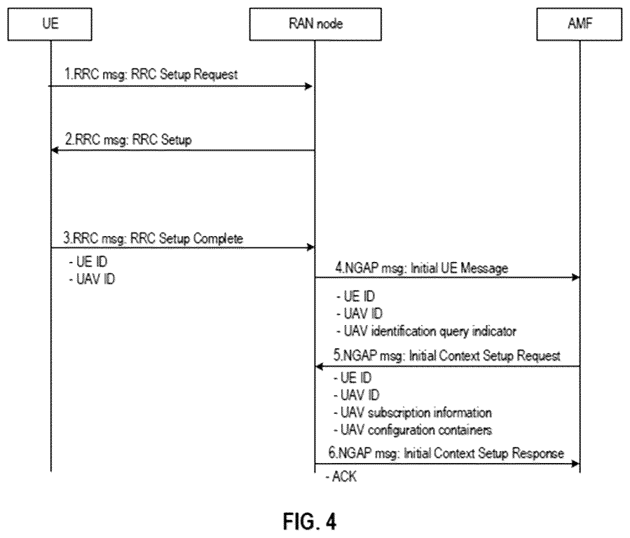

FIG. 5 illustrates a sequence diagram illustrating core network (CN) based unmanned aerial vehicle (UAV) identification configuration, in accordance with some embodiments of the present disclosure; and

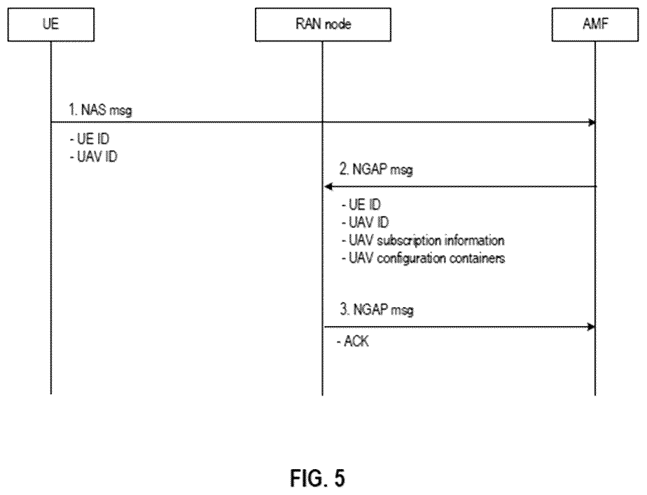

FIG. 6 illustrates a flow diagram for identifying subscription-based unmanned aerial vehicle (UAV), in accordance with an embodiment of the present disclosure.

### DETAILED DESCRIPTION

### 1. Mobile Communication Technology and Environment

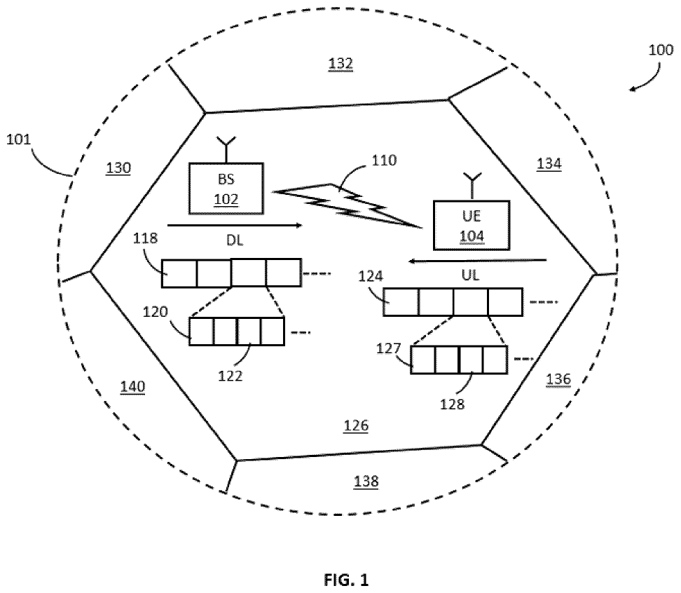

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

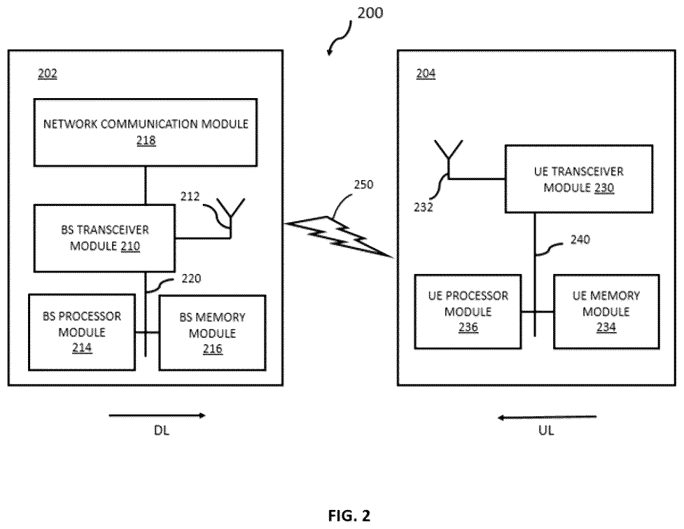

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuity that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for Identifying Subscription-Based Unmanned Aerial Vehicle (UAV)

Subscription-based unmanned aerial vehicle (UAV) identification can be a part of the UAV work item description (WID) in Rel-18. Currently, new radio (NR) may not support any UAV technology. By using the procedure introduced in this disclosure, the network can check whether a UE has a subscribed UAV service. If the UE has subscribed the UAV service, the network may configure UAV related measurements to the UE and may send approval information to a radio access network (RAN) node. The UE can use the UAV service. If the UAV has not subscribed the UAV service, the network may treat the UE as a common UE or based on network's implementation. In addition, to keep the UAV service continuity when a UE is moving in a heterogeneous area (e.g. an area with both LTE base stations and NR base stations), the network can configure the UAV configurations containers to the RAN node. The UAV service is supported in LTE specification. The UAV is not supported in Rel-18 NR specifications. In WID, companies may prefer to support the UAV features in NR and may consider LTE mechanism as baseline.

### Implementation Example 1: UAV Configuration Containers

This implementation example explains reasons on why UAV configuration containers may be introduced for an inter-RAT handover. For a heterogeneous network, an inter-system handover (HO) (e.g., IIO between gNB and eNB with changing of core network (CN) between access and mobility management function (AMF) and mobility management entity (MME)) and intra-system inter-radio access technology (RAT) (e.g., HO between gNB and ng-eNB. The CN may be AMF) handover may be performed during a UE mobility. To maximally maintain a UAV service continuity, a same UAV related configuration with different encoding/format for both NR and LTE may be configured to a RAN node in a different container. The UE may keep using a UAV related function no matter different RATs used between RAN nodes during the HO. The UAV configuration containers may be configured to the UE before the HO or during the HO.

In some embodiments, at least one of the following information may be added into both NR and LTE containers: a UAV identification (ID), UAV subscription information, report receiver's address(es), a UAV location configuration, a height reporting configuration, a flight path information configuration, or a measurement configuration. The UAV ID can be used/configured to identify a UAV. The UAV subscription information can include a flag which is used/configured to notify a RAN node that a UE is qualified to use the UAV service. The report receiver's address can include an IP address or URL for the UAV data collector. Different UAV data types may have the same destination or different destinations. The UAV location configuration can include information about UAV location measurement and reporting (e.g., an accurate requirement of the UAV location), what kinds of positioning methods may be used, a measurement/reporting frequency, and/or an integrity requirement. The height reporting configuration can include criteria on when the UE may report its height, measurement/reporting frequency, accuracy of the height measurement, and/or integrity requirement. The flight path information configuration can include a UE flight path history or prediction, a formula, a flight path (e.g., a list of cell ID, RAN node ID, coordinates), a number of points in the flight path list, a timestamp requirement, an accuracy requirement, an integrity requirement, and/or a reporting destination (e.g., IP or URL). The measurement configuration can include UE frequency-related measurement information (e.g., reference signal received power (RSRP), reference signal received quality (RSRQ), signal-to-noise and interference ratio (SINR) of cells).

### Implementation Example 2: Preamble Based UAV Identification

Some specific preambles may be defined by a RAN node for a UE with UAV features. If an IDLE UE wishes to switch to RRC_CONNECTED and to apply for network supported UAV functions, the US may use specific preambles for an initial access. If the RAN node detects the initial access with a special preamble, the RAN node may mark the UE as a potential UAV and may send a query information to a CN for further identification. Whether the UE can be treated as a UAV in the network may depend on a reply message from the CN. If the UAV information is valid, the CN may reply positive reply and may also further send a UAV configuration to RAN node. If the UAV info is not valid, the CN may reply the RAN node commonly. Whether the UE can be treated as a normal UE may depend on the implementation.

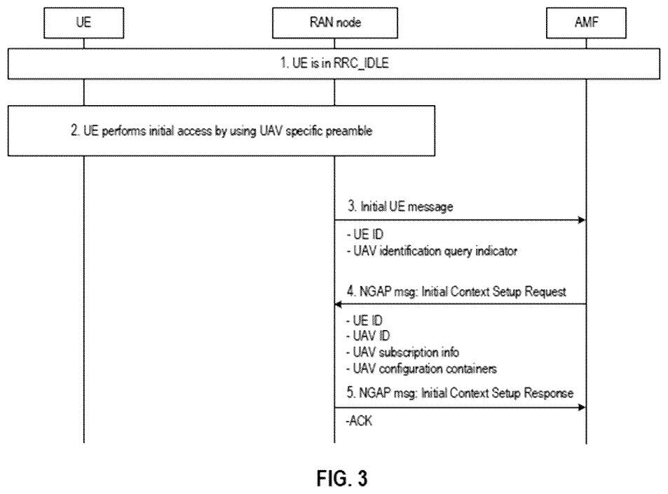

FIG. 3 is a call flow for preamble based UAV identification.

In step 1, a UE can be in RRC_IDLE at a start of this procedure.

In step 2, a UE may perform an initial access by using a UAV specific preamble.

In step 3, when a RAN node detects that a UE is processing the initial access procedure with the UAV specific preamble, at least one of following messages may be contained in a next generation application protocol (NGAP) message (e.g. initial UE message): UE identification information (e.g., a UE ID) or a UAV identification query indicator. The UAV identification can be used to query the CN whether a UE with the UE ID has subscribed UAV service. If the UE has subscribed the UAV service, the AMF may add the UAV related information into the following NGAP message. Otherwise, the AMF may process common NGAP procedures. In this implementation example, the UE may have subscribed the UAV function.

In step 4, when the AMF receives the above NGAP message (e.g., initial UE message) with the above information and confirms that the UE has subscribed the UAV service, the AMF may forward the NGAP message (e.g. initial context setup request message) with at least one of the following information: UE identification information (e.g., UE ID); UAV identification information (e.g., UAV ID); UAV subscription information (e.g., a flag which is used to notify the RAN node the UE is qualified to use UAV service); or UAV configuration containers (e.g., a LTE configuration container or a NR configuration container).

In step 5, the RAN node may receive the above NGAP message and may send the reply message (e.g., initial context setup response) to the AMF.

### Implementation Example 3: UE Based UAV Identification

The UAV subscription information (e.g., UAV ID) may be configured to a UE which has subscribed the UAV service. A UE may add the subscription information (e.g., UAV ID) into a RRC message and may activate the UAV function. When the RAN node receives the information, the RAN node may forward the received ID to a CN for further checking. If the UAV information is valid, the CN may reply positive reply and may also further send a UAV configuration to RAN node. If the UAV info is not valid, the CN may reply the RAN node commonly. The UE can still be treated as a normal UE.

In step 1, a UE may send a radio resource control (RRC) setup request message to a RAN node.

In step 2, the RAN node may send a RRC setup message to the UE.

In step 3, the UE may have subscribed a UAV service. The UE may add at least one of the following information into the RRC message (e.g., RRC setup complete) and may forward the RRC message to the RAN node. The at least one of the information may include: UE identification information (e.g., a UE ID) or UAV identification information (e.g., a UAV ID).

In step 4, the RAN node may receive the UAV information and may forward the UAV information to the AMF via a NGAP message (e.g., initial UE message). At least one of the following information may be contained in the NGAP message: UE identification information (e.g., a UE ID), UAV identification information (e.g., a UAV ID), or a UAV identification query indicator. The UAV identification query indicator is used to query the CN whether a UE with the UE ID has subscribed the UAV service.

In step 5, the AMF may receive the UAV subscription information and may check if the UE is qualified to activate UAV service. The AMF may send a NGAP message (e.g., initial context setup request message) to the RAN node. For a qualified UE, at least one of the following information may be added into the message: UE identification information (e.g., a UE ID), UAV identification information (e.g., a UAV ID), UAV subscription information (e.g., a flag which is used to notify the RAN node the UE is qualified to use the UAV service.), UAV configuration containers (e.g., a LTE configuration container or a NR configuration container).

In step 6, when the RAN node receives the above information, the RAN node may know the UE can use the UAV service. The RAN node may send a reply NGAP message (e.g., initial context setup response message) to the AMF.

### Implementation Example 4: CN Based UAV Identification

In step 1, the UE may send a non-access stratum (NAS) message to the AMF. At least one of the following information may be added into the NAS message: UE identification information (e.g., a UE ID), UAV identification information (e.g., a UAV ID).

In step 2, when the AMF receives the NAS message with the above information, the AMF may check whether the UAV subscription information is valid. If yes, the AMF may send a NGAP message to a RAN node. At least one of the following information may be added into the NGAP message: UE identification information (e.g., a UE ID), UAV identification information (e.g., a UAV ID), UAV subscription information (e.g., a flag which is used to notify the RAN node the UE is qualified to use the UAV service.), UAV configuration containers (e.g., a LTE configuration container or a NR configuration container).

In step 3, when the RAN node receives the above information, the RAN node may know the UE can use UAV functions. The RAN node may send a reply NGAP message (e.g., ACK) to AMF.

It should be understood that one or more features from the above implementation examples are not exclusive to the specific implementation examples, but can be combined in any manner (e.g., in any priority and/or order, concurrently or otherwise).

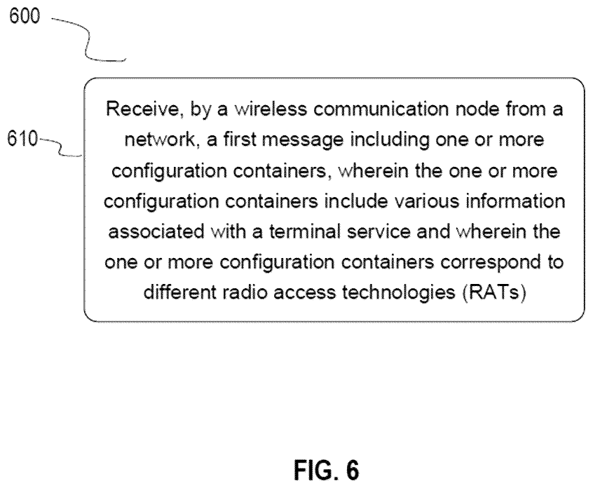

FIG. 6 illustrates a flow diagram of a method 600 for identifying subscription-based unmanned aerial vehicle (UAV). The method 600 may be implemented using any one or more of the components and devices detailed herein in conjunction with FIGS. 1-2. In overview, the method 600 may be performed by a wireless communication node, in some embodiments. Additional, fewer, or different operations may be performed in the method 600 depending on the embodiment. At least one aspect of the operations is directed to a system, method, apparatus, or a computer-readable medium.

A wireless communication node (e.g., a BS) may receive a first message including one or more configuration containers from a network (e.g., a CN). The one or more configuration containers may include various information associated with a terminal (e.g., an unmanned aerial vehicle (UAV)) service. The one or more configuration containers may correspond to different radio access technologies (RATs).

In some embodiments, the one or more configuration containers may include at least one of a Long-Term Evolution (LTE) configuration container or a New Radio (NR) configuration container. The various information may include at least one of: UAV identification configured to identify a wireless communication device; UAV subscription information configured to notify the wireless communication node that the wireless communication device is qualified to use the UAV service; one or more report receiver's addresses to which UAV data is to be collected; UAV location information configuring UAV location measurement and reporting; height reporting information associated with the wireless communication device; flight path information associated with the wireless communication device; or measurement information including frequency-related information of the wireless communication device.

In some embodiments, the wireless communication node may receive a second message including a UAV specific preamble from a wireless communication device (e.g., a UE). The wireless communication node may send a third message including at least one of: identification of the wireless communication device or an UAV identification query indicator to the network. The UAV identification query indicator can be configured to query the network whether the identification of the wireless communication device has subscribed to the UAV service. The wireless communication node may receive a fourth message confirming that the wireless communication device has subscribed to the UAV service from the network. The fourth message may include at least one of: the identification of the wireless communication device; UAV identification; UAV subscription information; or the one or more configuration containers

In some embodiments, the wireless communication node may receive a second message which can be a Radio Resource Control (RRC) message from a wireless communication device. The second message may include at least one of: identification of the wireless communication device or UAV identification. The wireless communication node may send a third message including at least one of: the identification of the wireless communication device; the UAV identification; or an UAV identification query indicator to the network. The wireless communication node may receive a fourth message confirming that the wireless communication device has subscribed to the UAV service from the network. The fourth message may includes at least one of: the identification of the wireless communication device; the UAV identification; UAV subscription information; or the one or more configuration containers.

In some embodiments, in response to the network receiving a Non-Access Stratum (NAS) message from a wireless communication device that includes at least one of identification of the wireless communication device or UAV identification, the wireless communication node may receive a first message confirming that the wireless communication device has subscribed to the UAV service from the network. The first message may include at least one of: the identification of the wireless communication device; the UAV identification; UAV subscription information; or the one or more configuration containers.

In some embodiments, a network (e.g., a CN) may send a first message including one or more configuration containers to a wireless communication node (e.g., a BS). The one or more configuration containers may include various information associated with a terminal (e.g., an unmanned aerial vehicle (UAV)) service. The one or more configuration containers may correspond to different radio access technologies (RATs).

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module”), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

what is claimed is:

1. A wireless communication method, comprising:
receiving, by a wireless communication node from a network, a first message including a plurality of configuration containers,
wherein the plurality of configuration containers includes information associated with a terminal service and wherein the plurality of configuration containers corresponds to different radio access technologies (RATs), and
wherein the information includes unmanned aerial vehicle (UAV) subscription information configured to notify the wireless communication node that a wireless communication device is qualified to use an UAV service.

2. The wireless communication method of claim 1, wherein the plurality of configuration containers includes at least one of a Long-Term Evolution (LTE) configuration container or a New Radio (NR) configuration container.

3. The wireless communication method of claim 1, wherein the network receives a Non-Access Stratum (NAS) message from a wireless communication device that includes an unmanned aerial vehicle (UAV) identification, and
wherein the first message indicates that the wireless communication device has subscribed to an UAV service.

4. A wireless communication method, comprising:
sending, by a network to a wireless communication node, a first message including a plurality of configuration containers;
wherein the plurality of configuration containers includes various information associated with a terminal service and wherein the plurality of configuration containers corresponds to different radio access technologies (RATs), and
wherein the information includes unmanned aerial vehicle (UAV) subscription information configured to notify the wireless communication node that a wireless communication device is qualified to use an UAV service.

5. The wireless communication method of claim 4, wherein the plurality of configuration containers includes at least one of a Long-Term Evolution (LTE) configuration container or a New Radio (NR) configuration container.

6. The wireless communication method of claim 4, further comprising:
receiving, by the network, a Non-Access Stratum (NAS) message from a wireless communication device that includes an unmanned aerial vehicle (UAV) identification,
wherein the first message indicates that the wireless communication device has subscribed to an UAV service.

7. A wireless communication node, comprising:
at least one processor configured to:
receive, via a receiver from a network, a first message including a plurality of configuration containers,
wherein the plurality of configuration containers includes information associated with a terminal service and wherein the plurality of configuration containers corresponds to different radio access technologies (RATs), and
wherein the information includes unmanned aerial vehicle (UAV) subscription information configured to notify the wireless communication node that a wireless communication device is qualified to use an UAV service.

8. The wireless communication node of claim 7, wherein the plurality of configuration containers includes at least one of a Long-Term Evolution (LTE) configuration container or a New Radio (NR) configuration container.

9. The wireless communication node of claim 7, wherein the network receives a Non-Access Stratum (NAS) message from a wireless communication device that includes an unmanned aerial vehicle (UAV) identification, and
wherein the first message indicates that the wireless communication device has subscribed to an UAV service.

10. A network node, comprising:
at least one processor configured to:
send, via a transmitter to a wireless communication node, a first message including a plurality of configuration containers;
wherein the plurality of configuration containers includes various information associated with a terminal service and wherein the plurality of configuration containers corresponds to different radio access technologies (RATs), and
wherein the information includes unmanned aerial vehicle (UAV) subscription information configured to notify the wireless communication node that a wireless communication device is qualified to use an UAV service.

11. The network node of claim 10, wherein the plurality of configuration containers includes at least one of a Long-Term Evolution (LTE) configuration container or a New Radio (NR) configuration container.

12. The network node of claim 10, wherein the at least one processor is configured to receive a Non-Access Stratum (NAS) message from a wireless communication device that includes an unmanned aerial vehicle (UAV) identification, and
wherein the first message indicates that the wireless communication device has subscribed to an UAV service.

13. A non-transitory computer-readable program medium having code stored thereupon, the code, when executed by at least one processor, causes the at least one processor to implement the method of claim 1.

14. A non-transitory computer-readable program medium having code stored thereupon, the code, when executed by at least one processor, causes the at least one processor to implement the method of claim 2.

15. A non-transitory computer-readable program medium having code stored thereupon, the code, when executed by at least one processor, causes the at least one processor to implement the method of claim 3.

16. A non-transitory computer-readable program medium having code stored thereupon, the code, when executed by at least one processor, causes the at least one processor to implement the method of claim 4.

17. A non-transitory computer-readable program medium having code stored thereupon, the code, when executed by at least one processor, causes the at least one processor to implement the method of claim 5.

18. A non-transitory computer-readable program medium having code stored thereupon, the code, when executed by at least one processor, causes the at least one processor to implement the method of claim 6.
